(19) United States
(12) Patent Application Publication
(10) Pub. No.: US 2007/0166125 A1
(43) Pub. Date: Jul. 19, 2007

(54) PIN MEMBER FOR GRAIN BIN DOOR

(75) Inventors: Charles E. Sukup, Dougherty, IA (US); Steven E. Sukup, Clear Lake, IA (US); Eugene G. Sukup, Hampton, IA (US)

Correspondence Address: ZARLEY LAW FIRM P.L.C., CAPITAL SQUARE, 400 LOCUST, SUITE 200, DES MOINES, IA, 50309-2350, US

(73) Assignee: SUKUP MANUFACTURING COMPANY, Sheffield, IA (US)

(21) Appl. No.: 11/306,929

(22) Filed: Jan. 17, 2006

(51) Int. Cl. F16B 35/06

(52) U.S. Cl. 411/399

(57) ABSTRACT

A pin member having a first section having a first rounded end and a second end and having a second section extending outwardly from the second end of the first section and having a diameter less than the diameter of the first section to form a shoulder. Extending from the shoulder is a third section having a diameter that is less than the diameter of the second section and that is an elongated cylindrical section that may be threaded. This pin member is inserted through a grain bin door jamb and cover to secure the door jamb and cover.

### BACKGROUND OF THE INVENTION

The invention relates to a pin member, and more specifically a pin member for a grain bin door.

Many storage structures such as grain bins have access openings that are closed by a cover door. This cover door, or cover, is exposed to a significant amount of forces exerted thereon by the weight of the material being stored within the grain bin. Cover doors have a plurality of bores which engage with respective protuberances or pins on the storage structure adjacent the access opening. Thus, as hoop stresses are applied to the storage structure by the weight of the material being stored, the hoop stresses can pass through the cover member by means of tensile force exerted between a structure protuberance and a respective cover bore.

In the art current pin members consist of multiple parts including a bolt that extends through a pin member that has a tapered portion and uses a washer and a nut to secure the cover and a door jamb of the storage structure. Such a pin member is more complex and expensive to manufacture. Additionally, because of the number of parts, installing the current pin members is more complex and difficult. Furthermore, by having the bolt extending through the pin member the end of the bolt is exposed outside of the cover and individuals may be scratched or nicked by this exposed bolt.

Accordingly, there is a need in the art for a new pin member used to secure a cover of a grain bin to a door jamb of a grain bin.

Therefore, a principal object of the present is to provide a pin member that is more economical to manufacture.

Another object of the present invention is to provide a pin member made of a single piece.

Yet another object of the present invention is to provide a pin member that is easily installed.

These and other objects, features, or advantages of the present invention will become apparent.

### BRIEF SUMMARY OF THE INVENTION

A pin member for use in a grain bin to secure a door jamb to a cover. The pin member has an elongated body having a first section, a second section, and a third section. The first section has a rounded first end and a flat second end. Extending outwardly from the first section is a second section that has a diameter less than the diameter of the first section. The third section extends outwardly from the second section and has a diameter less than the diameter of the second section. The third section has a threaded exterior surface.

### BRIEF DESCRIPTION OF THE DRAWINGS

FIG. 1 is a side plan view of a storage structure;

FIG. 2 is a side plan view of a door of a storage structure;

FIG. 3 is a sectional view of a pin member securing a door jamb to a cover of a door of a storage structure;

FIG. 4 is a sectional view of a pin member securing a door jamb to a cover of a door of a storage structure;

FIG. 5 is a sectional view of a pin member securing a door jamb to a cover of a door of a storage structure; and

FIG. 6 is a sectional view of a pin member securing a door jamb to a cover of a door of a storage structure.

### DETAILED DESCRIPTION OF THE PREFERRED EMBODIMENT

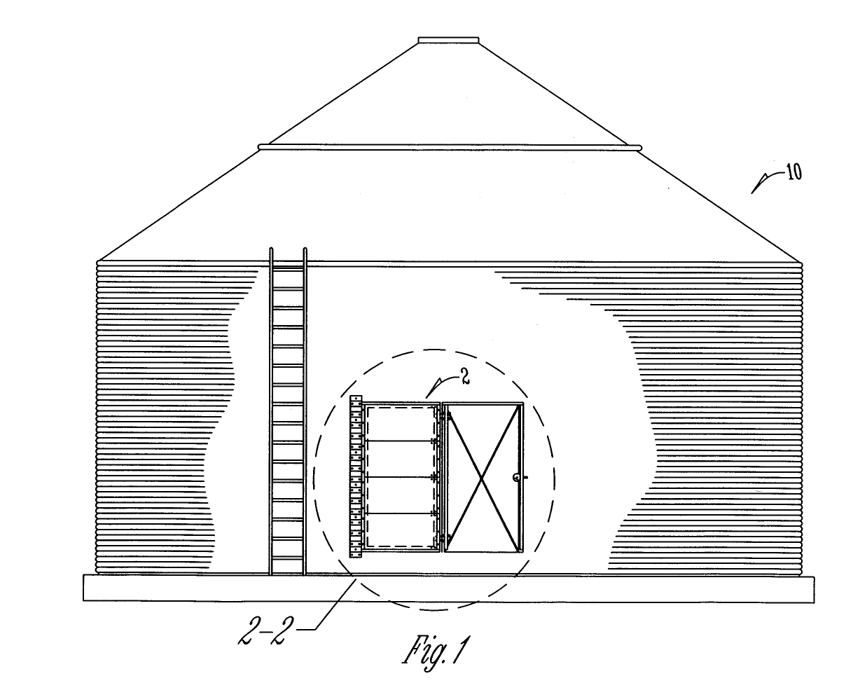

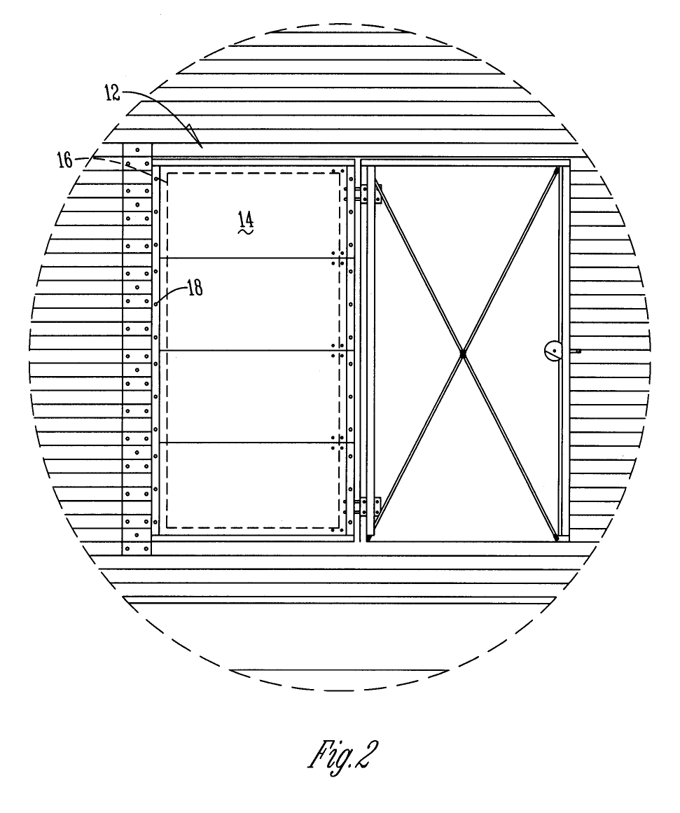

FIG. 1 shows a storage structure 10 such as a grain bin. The storage structure 10 has a door 12 (FIG. 2) that comprises a plurality of covers 14 that prevent the contents of the storage structure 10 from spilling out of the storage structure 10. Covers 14 are attached to a plurality of door jambs 16 with a plurality of pin members 18 to hold the covers 14 in place.

FIG. 3 shows a pin 18 when it is within a door jamb 16 and a cover 14 of a grain bin. The pin member 18 has a first section 20, a second section 22 extending from the first section 20 and a third section 24 extending outwardly from the second section 22. The first section 20 has a generally cylindrical body portion that has a first rounded end 28 and a second end 30. The rounded first end 28 provides a smooth surface that prevents a person from catching clothing on the surface or from scraping a body part on the surface.

Extending from the first section 20 is a second section 22 that has a diameter less than the first section 20. In a preferred embodiment the second section 22 extends adjacent the sidewall of the first hole 44 towards a third section 24. Alternatively the second section 22 tapers inwardly towards the third section 24 to form a tapered side wall.

Extending from the second section 22 is the third section 24 having a diameter less than the diameter of the second section 22. The third section also has an elongated cylindrical body, or stem, having a first end 34 that extends from the second section 22 and a second opposite end 36. In one embodiment the third section 24 has a plurality of threads 38.

To install the pin 18, the pin is inserted through hole 44 of door jamb 16. The diameter of the first section 20 of the pin 18 is greater than the diameter of hole 44 such that end 30 of the first section 20 engages the outer surface 40 of the door jamb 16. The second section 22 fits within hole 44 with the third section 24 extending outwardly from surface 42 of the door jamb 16. A support strap 48 that extends the length of the door jamb 16 has a plurality of openings 50 therein and is placed over the third section 24 of the pin 18. Alternatively, a washer is used with each pin 18 instead of the support strap 48. A nut 52 is threadably mated to the third section 24 to compress the support strap 48 against surface 42 and pull end 30 against surface 40 to create a snug fit between the pin and the door jamb 16. The cover 14 can then be closed such that bore 46 of the cover fits over the first section 20 of the pin 18 and engages surface 40 of the door jamb 16.

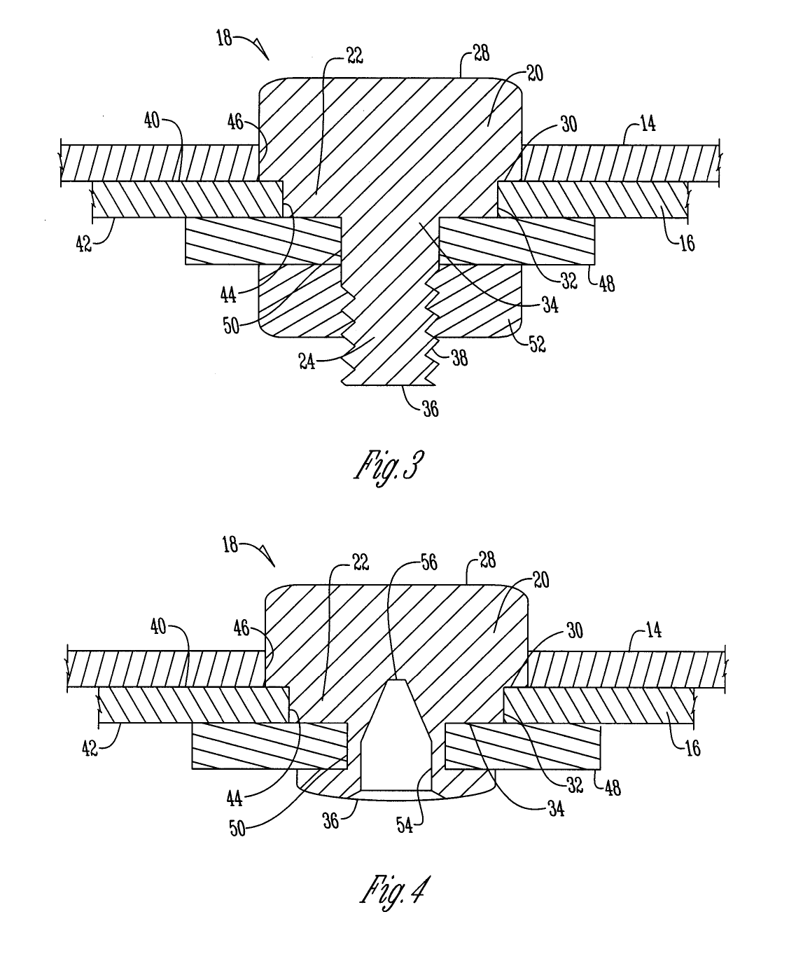

In an alternative embodiment, as shown in FIG. 4, the pin 18 has a void or chamber 54 that extends toward sections 20 and 22 of pin 18 from end 36. Preferably, chamber 54 tapers as it extends from end 36 to section 20. The chamber 54 is formed such that end 36 is hammered, flared, riveted or compressed against the support strap 48 to secure the pin 18.

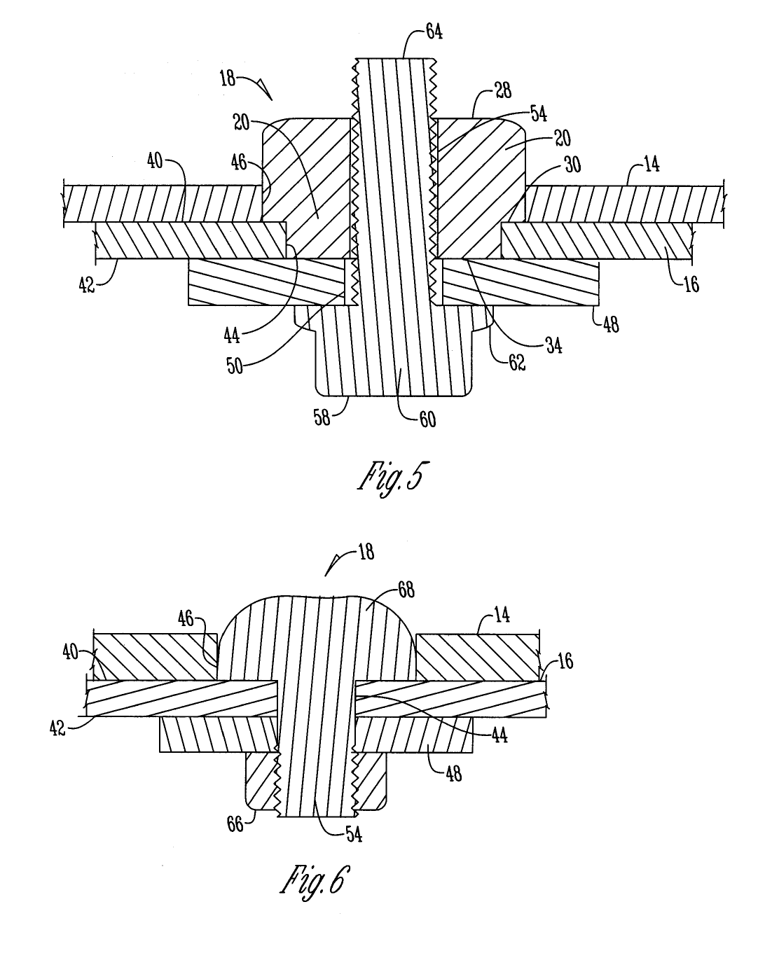

FIG. 5 shows another alternative embodiment where a threaded bore 54 is disposed through the center of the pin 18. A bolt 58 is threadably received within bore 54 to secure the pin 18. Specifically, the bolt 58 has a head 60 that forms a shoulder 62 that engages support strap 48. A threaded stem 64 extends from the head and is threadably received within bore 54. Alternatively, a nut element is threadably mounted on an end of the stem 64 that extends through bore 54.

In another embodiment, as shown in FIG. 6, the pin 18 has a head 68 with a partially threaded stem 54 of uniform diameter. The head 68 fits snuggly within hole 46 and the stem 54 fits snuggly within hole 44 with each having a diameter slightly less than the diameter of the respective hole. Preferably, the stem 54 is of ⅝″ diameter. A nut 66 is threaded onto the stem 54 to secure the pin 18.

It will be appreciated by those skilled in the art that other various modifications could be made to the device without the parting from the spirit in scope of this invention. All such modifications and changes fall within the scope of the claims and are intended to be covered thereby.

What is claimed is:

1. A pin member for a doorjamb and cover of a grain bin comprising:
an elongated body having a first section, a second section, and a third section;
the second section extending outwardly from the first and having a diameter less than a diameter of the first section; and
the third section extending outwardly from the second section and having a diameter less than the diameter of the second section.

2. The pin member of claim 1 wherein the first section has a rounded end.

3. The pin member of claim 1 wherein the third section has a threaded exterior surface.

4. A pin member for a door jamb and cover of a grain bin comprising:
an elongated body having a first section, a second section, and a third section;
the second section extending outwardly from the first and having a diameter less than a diameter of the first section; and
the third section extending outwardly from the second section and compressed to engage a support strap.

5. The pin member of claim 4 wherein the third section has a bore disposed therethrough.

6. The pin member of claim 5 wherein the bore is disposed through and tapers toward the second section.

7. A pin member for a door jamb and cover of a grain bin comprising:
an elongated body having a first section and a second section;
the second section extending outwardly from the first and having a diameter less than a diameter of the first section;
a bore having concentric threads; and
a bolt disposed through the bore and secured to the elongated body.

8. A pin member for a door jamb and cover of a grain bin comprising:
a head,
a stem having a threaded portion extending from the head having a diameter less than the head, the head having a diameter less than the diameter of a bore in the cover, and the stem having a diameter less than the diameter of a bore in the door jamb.
